(19) United States
(12) Patent Application Publication
(10) Pub. No.: US 2022/0255083 A1
(43) Pub. Date: Aug. 11, 2022

(54) NONAQUEOUS ELECTROLYTE SECONDARY BATTERY

(71) Applicant: Panasonic Intellectual Property Management Co., Ltd., Osaka (JP)

(72) Inventor: MASAHISA FUJIMOTO, Osaka (JP)

(21) Appl. No.: 17/728,987

(22) Filed: Apr. 26, 2022

Related U.S. Application Data
(63) Continuation of application No. PCT/JP2020/016986, filed on Apr. 20, 2020.

(30) Foreign Application Priority Data
Nov. 22, 2019 (JP) 2019-211855

(51) Int. Cl. H01M 4/66; H01M 10/0569

(52) U.S. Cl. CPC H01M 4/661; H01M 2004/027; H01M 2300/0028; H01M 10/0569

(57) ABSTRACT

A nonaqueous electrolyte secondary battery includes a positive electrode capable of occluding and releasing lithium, a negative electrode including a negative electrode current collector, and an electrolyte solution including a solvent. In the nonaqueous electrolyte secondary battery, lithium metal precipitates on the negative electrode during charging. The lithium metal dissolves in the electrolyte solution during discharging. The solvent is composed only of vinylene carbonate.

### BACKGROUND

### 1. Technical Field

The present disclosure relates to a nonaqueous electrolyte secondary battery.

2. Description of the Related Art

There has been extensive research and development of lithium secondary batteries. The battery characteristics, such as charge and discharge voltages, charge-discharge cycle characteristics, and storage characteristics, of a lithium secondary battery vary by the electrodes included in the lithium secondary battery. There have been attempts to enhance battery characteristics by improving an electrode active material.

Japanese Unexamined Patent Application Publication No. 2005-268230 discloses a nonaqueous electrolyte secondary battery that includes a negative electrode composed of metal lithium or non-graphitizable carbon material, a positive electrode, and a nonaqueous electrolyte solution. In Japanese Unexamined Patent Application Publication No. 2005-268230, it is described that a nonaqueous electrolyte secondary battery that includes vinylene carbonate as a nonaqueous solvent has suitable cycle characteristics.

### SUMMARY

In one general aspect, the techniques disclosed here feature a nonaqueous electrolyte secondary battery that includes a positive electrode capable of occluding and releasing lithium; a negative electrode including a negative electrode current collector; and an electrolyte solution including a solvent. Lithium metal precipitates on the negative electrode during charging. The lithium metal dissolves in the electrolyte solution during discharging. The solvent is composed only of vinylene carbonate.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a longitudinal cross-sectional view of a nonaqueous electrolyte secondary battery according to an exemplary embodiment of the present disclosure;

FIG. 2 is a graph illustrating the results of a cycle test of the nonaqueous electrolyte secondary batteries prepared in Example and Comparative examples 1 to 4; and

FIG. 3 is a partial enlarged view of the graph illustrated in FIG. 2.

### DETAILED DESCRIPTIONS

### Underlying Knowledge Forming Basis of the Present Disclosure

The use of lithium metal as a negative electrode active material enables the production of a lithium secondary battery having high gravimetric and volumetric energy densities. However, in such a lithium secondary battery, part of the lithium metal precipitated on the negative electrode during charging may react with the electrolyte solution. This reaction may reduce the round-trip efficiency of the lithium secondary battery that includes lithium metal as a negative electrode active material and degrade the cycle characteristics of the lithium secondary battery.

The inventor of the present invention conducted extensive studies in order to address the above-described issues and consequently devised the nonaqueous electrolyte secondary battery according to the present disclosure, which is described below.

### Summary of Aspects of Present Disclosure

An nonaqueous electrolyte secondary battery according to a first aspect of the present disclosure includes:

a positive electrode capable of occluding and releasing lithium;

a negative electrode including a negative electrode current collector; and

an electrolyte solution including a solvent.

Lithium metal precipitates on the negative electrode during charging. The lithium metal dissolves in the electrolyte solution during discharging. The solvent is composed only of vinylene carbonate.

Since the nonaqueous electrolyte secondary battery according to the first aspect includes an electrolyte solution including a solvent composed only of vinylene carbonate, a dense coating film is formed on the surface of the negative electrode as a result of the reduction of vinylene carbonate. During charging, lithium metal precipitates between the coating film and the negative electrode. That is, the coating film protects the lithium metal precipitated on the negative electrode and thereby reduces the likelihood of the electrolyte solution coming into contact with the precipitated lithium metal. This suppresses the reaction between the electrolyte solution and the precipitated lithium metal and may consequently enhance the cycle characteristics of the nonaqueous electrolyte secondary battery according to the first aspect.

According to a second aspect of the present disclosure, for example, in the nonaqueous electrolyte secondary battery according to the first aspect, the negative electrode current collector may be composed of a metal that does not alloy with lithium.

According to the second aspect, a nonaqueous electrolyte secondary battery having improved cycle characteristics may be produced.

According to a third aspect of the present disclosure, for example, in the nonaqueous electrolyte secondary battery according to the first or second aspect, the negative electrode current collector may include copper.

Since copper has a considerably high electrical conductivity, the current collection characteristics of the negative electrode current collector may be enhanced. Thus, the nonaqueous electrolyte secondary battery according to the third aspect may have further improved cycle characteristics.

A nonaqueous electrolyte secondary battery according to an exemplary embodiment of the present disclosure is described below. The present disclosure is not limited by the exemplary embodiment below.

### Exemplary Embodiment

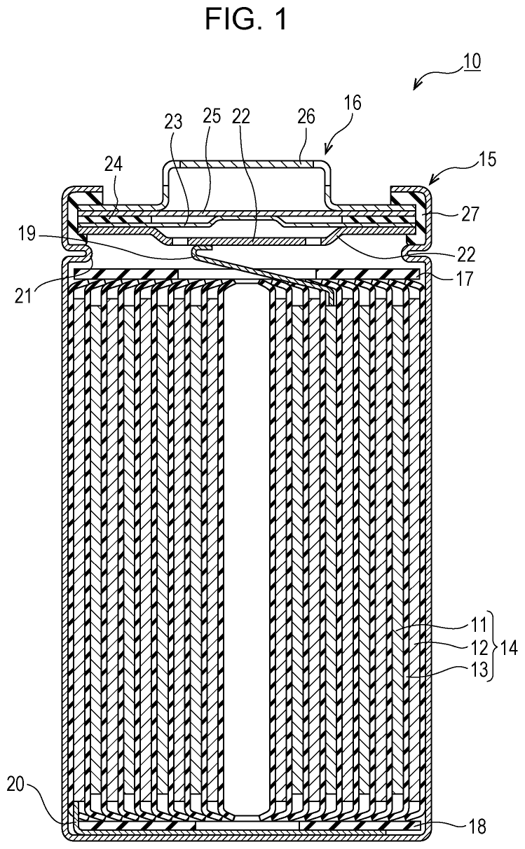

FIG. 1 is a schematic longitudinal cross-sectional view of a nonaqueous electrolyte secondary battery 10 according to an exemplary embodiment of the present disclosure. As illustrated in FIG. 1, the nonaqueous electrolyte secondary battery 10 is a cylindrical battery that includes a cylindrical battery casing, a wound electrode group 14, and an electrolyte solution (not illustrated). The electrode group 14 is disposed in the battery casing and arranged in contact with the electrolyte solution.

The battery casing is constituted by a casing main body 15 that is a closed-end cylindrical metal container and a sealing plate 16 with which the opening of the casing main body 15 is sealed. A gasket 27 is interposed between the casing main body 15 and the sealing plate 16. The gasket 27 enables the battery casing to be hermetically sealed. In the casing main body 15, insulating plate 17 and 18 are disposed at the respective ends of the electrode group 14 in the direction of the axis around which the electrode group 14 is wound (hereinafter, this axis is referred to as “winding axis”).

The casing main body 15 includes, for example, a step 21. The step 21 may be formed by pressing a portion of the side wall of the casing main body 15 from the outside of the casing main body 15. The step 21 may be formed on the side wall of the casing main body 15 in a circular shape in the circumferential direction of a virtual circle defined by the casing main body 15. In such a case, the sealing plate 16 is supported by, for example, the opening-side surface of the step 21.

The sealing plate 16 includes a filter 22, a lower valve plate 23, an insulating member 24, an upper valve plate 25, and a cap 26, which are stacked on top of one another in this order. The sealing plate 16 is attached to the opening of the casing main body 15 such that the cap 26 is located on the outer side of the casing main body 15 and the filter 22 is located on the inner side of the casing main body 15.

Each of the above components of the sealing plate 16 may have, for example, a disc-like shape or a ring-like shape. The above-described components other than the insulating member 24 are electrically connected to one another.

The electrode group 14 includes a positive electrode 11, a negative electrode 12, and a separator 13. The positive electrode 11, the negative electrode 12, and the separator 13 are all band-like. For example, the transverse directions of the band-like positive electrode 11 and negative electrode 12 are parallel to the winding axis of the electrode group 14. The separator 13 is interposed between the positive electrode 11 and the negative electrode 12. The positive electrode 11 and the negative electrode 12 are wound into a spiral with the separator 13 being interposed between the two electrodes.

When a cross section of the nonaqueous electrolyte secondary battery 10 which is orthogonal to the winding axis of the electrode group 14 is observed, the positive electrode 11 and the negative electrode 12 are alternately stacked on top of each other in the radial direction of a virtual circle defined by the casing main body 15 with the separator 13 being interposed between the two electrodes.

The positive electrode 11 is electrically connected to the cap 26, which serves also as a positive terminal, with a positive electrode lead 19. An end of the positive electrode lead 19 is connected to, for example, a portion of the positive electrode 11 which is in the vicinity of the center of the positive electrode 11 in the longitudinal direction. The positive electrode lead 19 extends from the positive electrode 11 to the filter 22 through a through-hole formed in the insulating plate 17. The other end of the positive electrode lead 19 is, for example, welded to a surface of the filter 22 which faces the electrode group 14.

The negative electrode 12 is electrically connected to the casing main body 15, which serves also as a negative terminal, with a negative electrode lead 20. An end of the negative electrode lead 20 is connected to, for example, an end of the negative electrode 12 in the longitudinal direction. The other end of the negative electrode lead 20 is, for example, welded to the inner bottom of the casing main body 15.

Each of the components of the nonaqueous electrolyte secondary battery 10 is specifically described below.

### Positive Electrode 11

The positive electrode 11 is capable of occluding and releasing lithium. The positive electrode 11 includes, for example, lithium. The positive electrode 11 may include a positive electrode current collector and a positive electrode active material layer. The positive electrode active material layer is, for example, disposed on the positive electrode current collector. The positive electrode active material layer is, for example, disposed on the surface of the positive electrode current collector so as to come into direct contact with the positive electrode current collector. The positive electrode current collector and the positive electrode active material layer are, for example, band-like. The positive electrode current collector has, for example, a pair of principal surfaces opposite to each other. The term “principal surface” used herein refers to a surface of the positive electrode current collector which has the largest area. In the positive electrode 11, two positive electrode active material layers may be disposed on the respective principal surfaces of the positive electrode current collector. Note that, in the positive electrode 11, one positive electrode active material layer may be disposed on only one of the principal surfaces of the positive electrode current collector. The positive electrode active material layer may be disposed on only one of the principal surfaces of the positive electrode current collector in at least one selected from the group consisting of a region of the positive electrode 11 which is connected to the positive electrode lead 19 and a region of the positive electrode 11 which does not face the negative electrode 12.

The positive electrode current collector may be any of the positive electrode current collectors included in the nonaqueous electrolyte secondary batteries known in the related art. Examples of the material constituting the positive electrode current collector include metal materials, such as copper, stainless steel, iron, and aluminum.

The positive electrode active material layer is a layer that includes a positive electrode active material. The positive electrode active material may be a material capable of reversibly occluding and releasing lithium ions. The positive electrode active material is, for example, a material that includes lithium and is capable of occluding and releasing lithium. Examples of the positive electrode active material include a transition metal oxide, a fluoride, a polyanion, a fluorinated polyanion, a transition metal sulfide, and a phosphate having an olivine structure. Examples of the transition metal oxide include LiCoO₂, LiNiO₂, and Li₂Mn₂O₄. Examples of the above phosphate include LiFePO₄, LiNiPO₄, and LiCoPO₄. The positive electrode active material layer may include a plurality of positive electrode active materials.

The positive electrode active material layer may optionally include a conductive agent, an ionic conductor, and a binder as needed.

The conductive agent and the ionic conductor are used for reducing the resistance of the positive electrode 11.

### Examples of the Conductive Agent Include the Following:

(i) carbon materials (i.e., carbon conductive agents), such as carbon black, graphite, acetylene black, carbon nanotubes, carbon nanofibers, graphene, fullerene, and graphite oxide; and

(ii) conductive polymers, such as polyaniline, polypyrrole, and polythiophene.

### Examples of the Ionic Conductor Include the Following:

(i) gel electrolytes, such as polymethyl methacrylate;

(ii) organic solid electrolytes, such as polyethylene oxide; and

(iii) inorganic solid electrolytes, such as Li₇La₃Zr₂O₁₂.

The binder is used for enhancing the binding property of the material constituting the positive electrode 11. Examples of the binder include polymeric materials, such as polyvinylidene fluoride, a vinylidene fluoride-hexafluoropropylene copolymer, a vinylidene fluoride-tetrafluoroethylene copolymer, polytetrafluoroethylene, carboxymethyl cellulose, polyacrylic acid, a styrene-butadiene copolymer rubber, polypropylene, polyethylene, and polyimide.

The positive electrode 11 may be composed of lithium metal. Using lithium metal as a positive electrode makes it easy to control the dissolution and precipitation as a metal positive electrode.

### Negative Electrode 12

Lithium metal precipitates on the negative electrode 12 of the nonaqueous electrolyte secondary battery 10 as a result of charging. Specifically, during charging, lithium ions included in the electrolyte solution receive electrons on the negative electrode 12 to form lithium metal, and the lithium metal precipitates on the negative electrode 12. The lithium ions included in the electrolyte solution are derived from at least one selected from the group consisting of, for example, lithium included in the positive electrode 11 and the lithium salt included in the electrolyte solution as an electrolyte salt. The lithium metal precipitated on the negative electrode 12 dissolves in the electrolyte solution in the form of lithium ions as a result of discharging. That is, in the nonaqueous electrolyte secondary battery 10, the lithium metal precipitated on the negative electrode 12 during charging is used as a negative electrode active material.

The negative electrode 12 includes a negative electrode current collector. The negative electrode current collector is, for example, band-like. The negative electrode current collector has, for example, a pair of principal surfaces opposite to each other.

The negative electrode current collector is commonly formed of a conductive sheet. The material constituting the negative electrode current collector may be a metal material, such as a metal or an alloy. The metal material may be any metal material unreactive with lithium. Specifically, the metal material may be a metal material that does not alloy with lithium. Examples of such a metal material include copper, nickel, iron, and alloys including the above metallic elements. Examples of the alloys include a copper alloy and a stainless steel. The negative electrode current collector may be composed of any of the above metal materials that do not alloy with lithium. The metal material may be at least one selected from the group consisting of copper and a copper alloy in order to increase electrical conductivity and the capacity and round-trip efficiency of the nonaqueous electrolyte secondary battery 10. The negative electrode current collector may include at least one selected from the above metal materials. The negative electrode current collector may include a conductive material other than the metal material.

Examples of the shape of the negative electrode current collector include a foil and a film. The negative electrode current collector may be porous. The negative electrode current collector may be a metal foil in order to increase electrical conductivity. The negative electrode current collector may be a metal foil including copper. Examples of the metal foil including copper include a copper foil and a copper alloy foil. The copper content in the metal foil may be equal to or greater than 50% by mass or may be equal to or greater than 80% by mass. In particular, the metal foil may be a copper foil that substantially includes copper only as a metal. The thickness of the negative electrode current collector is, for example, equal to or greater than 5 μm and equal to or less than 20 μm.

The negative electrode 12 may be composed only of the negative electrode current collector when the nonaqueous electrolyte secondary battery 10 is completely discharged.

### Separator 13

The separator 13 has, for example, ionic permeability and an insulation property. The separator 13 is a porous sheet or the like. Examples of the separator 13 include a microporous film, a woven fabric, and a nonwoven fabric. The material constituting the separator 13 is not limited and may be a polymeric material.

Examples of the polymeric material include an olefin resin, a polyamide resin, and cellulose. The olefin resin may include a polymer that includes at least one selected from the group consisting of ethylene and propylene as a monomer unit. The above polymer may be either a homopolymer or a copolymer. Examples of the polymer include polyethylene and polypropylene.

The separator 13 may further include, in addition to the polymeric material, an additive as needed. Examples of the additive include an inorganic filler.

### Electrolyte Solution

The electrolyte solution includes a solvent. The solvent is composed only of vinylene carbonate. Since the ring constituting vinylene carbonate includes a double bond, vinylene carbonate can be easily polymerized. Thus, vinylene carbonate is polymerized on the negative electrode 12 upon being reduced. As a result of the polymerization of vinylene carbonate upon reduction, a dense coating film composed of a polymer of vinylene carbonate is formed on the surface of the negative electrode 12. During charging, lithium metal precipitates between the coating film and the negative electrode 12. That is, the coating film protects the lithium metal precipitated on the negative electrode 12 and thereby reduces the likelihood of the electrolyte solution coming into contact with the precipitated lithium metal. This suppresses the reaction between the electrolyte solution and the precipitated lithium metal and may consequently enhance the cycle characteristics of the nonaqueous electrolyte secondary battery 10.

When vinylene carbonate is reduced while a lithium salt is present in the electrolyte solution, a polymer of vinylene carbonate which includes the lithium salt is formed. A coating film composed of the polymer including a lithium salt has lithium ion conductivity. Covering the surface of the negative electrode 12 with the coating film composed of the above polymer may suppress further reduction of vinylene carbonate. The reaction in which lithium metal precipitates on the negative electrode 12 occurs in the above-described manner. Consequently, the nonaqueous electrolyte secondary battery 10 may have a high round-trip efficiency.

If the electrolyte solution further includes a solvent other than vinylene carbonate, the resulting polymer includes at least one selected from the group consisting of the other solvent and the product of decomposition of the other solvent. In such a case, the surface of the negative electrode 12 may fail to be completely covered with a coating film composed of the polymer and, as a result, the precipitated lithium metal may come into direct contact with the electrolyte solution. The contact between the precipitated lithium metal and the electrolyte solution results in the reaction between the electrolyte solution and the precipitated lithium metal, which degrades cycle characteristics. Therefore, it is essential to use a solvent composed only of vinylene carbonate as a solvent for the electrolyte solution.

The electrolyte solution may further include an electrolyte salt. Examples of the electrolyte salt include lithium salts, such as LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, LiClO₄, and lithium bis(oxalate)borate. The above electrolyte salts may be used alone or in combination of two or more. The electrolyte solution may include lithium dissolved therein.

The concentration of the electrolyte salt in the electrolyte solution is not limited. The electrolyte salt may be dissolved in vinylene carbonate at a concentration of, for example, equal to or greater than 0.1 mol/L and equal to or less than 3.0 mol/L.

The lithium ions included in the electrolyte solution may be lithium ions derived from the lithium salt added to the electrolyte solution or lithium ions fed from the positive electrode 11 as a result of charging. The electrolyte solution may include both lithium ions derived from the lithium salt added to the electrolyte solution and lithium ions fed from the positive electrode 11 as a result of charging.

### Others

Although the battery illustrated in FIG. 1, that is, a cylindrical nonaqueous electrolyte secondary battery 10 that includes a cylindrical battery casing, is described in the above exemplary embodiment of the present disclosure, the nonaqueous electrolyte secondary battery according to the present disclosure is not limited to the battery illustrated in FIG. 1. Specifically, the nonaqueous electrolyte secondary battery according to the present disclosure may be, for example, a rectangular battery that includes a rectangular battery casing or a laminated battery that includes a resin package, such as an aluminum lamination sheet. The electrode group included in the nonaqueous electrolyte secondary battery according to the present disclosure is not limited to a wound electrode group. The electrode group included in the nonaqueous electrolyte secondary battery according to the present disclosure may be, for example, a multilayer electrode group that includes a plurality of positive electrodes and a plurality of negative electrodes that are alternately stacked on top of each other with a separator being interposed between each of the pairs of positive electrodes and negative electrodes.

### EXAMPLES

Further details of the nonaqueous electrolyte secondary battery according to the present disclosure are described with reference to Examples below. Note that Examples below are merely illustrative but not restrictive of the present disclosure.

### Example

A Cu foil (2 ×2 cm) and lithium metal were used as working and counter electrodes, respectively. The working electrode served as a negative electrode of a nonaqueous electrolyte secondary battery. The counter electrode served as a positive electrode of a nonaqueous electrolyte secondary battery. The Cu foil was doubly covered with a separator “3401” produced by Celgard, LLC. A solution prepared by dissolving LiPF₆ in vinylene carbonate (hereinafter, abbreviated as “VC”) at a concentration of 1.0 mol/L was used as an electrolyte solution. A test cell of Example was prepared in the above-described manner.

### Comparative Example 1

A test cell of Comparative example 1 was prepared as in Example, except that a mixed solvent including VC and methyl ethyl carbonate (hereinafter, abbreviated as “MEC”) at a volume ratio of 1:1 was used instead of VC.

### Comparative Example 2

A test cell of Comparative example 2 was prepared as in Example, except that a mixed solvent including VC and dimethyl carbonate (hereinafter, abbreviated as “DMC”) at a volume ratio of 4:6 (i.e., the volume ratio of VC:DMC was 4:6) was used instead of VC.

### Comparative Example 3

A test cell of Comparative example 3 was prepared as in Example, except that propylene carbonate (hereinafter, abbreviated as “PC”) was used instead of VC.

### Comparative Example 4

A test cell of Comparative example 4 was prepared as in Example, except that a mixed solvent including ethylene carbonate (hereinafter, abbreviated as “EC”) and MEC at a volume ratio of 1:3 (i.e., the volume ratio of EC:MEC was 1:3) was used instead of VC.

### Charge-Discharge Cycle Test

Each of the test cells prepared in Example and Comparative examples 1 to 4 was subjected to a charge-discharge cycle test in order to determine the cycle characteristics of the test cell. In each cycle, the test cell was charged at a constant current of 1 mA for 1 hour and subsequently discharged to a voltage of 1 V. Thirty cycles of charging and discharging was performed.

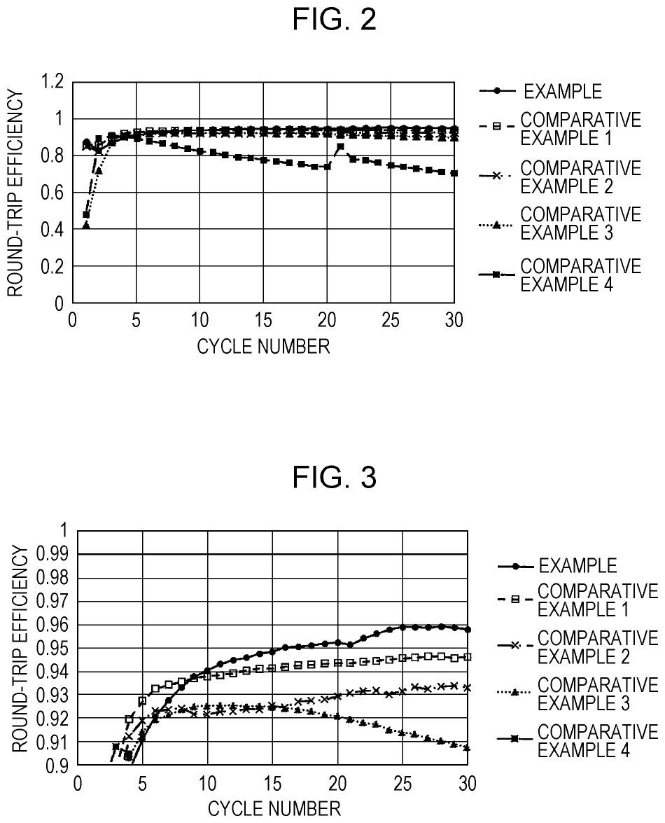

FIG. 2 is a graph illustrating the round-trip efficiencies measured in Example and Comparative examples 1 to 4. In FIG. 2, the horizontal and vertical axes show the number of cycles and round-trip efficiency, respectively. The round-trip efficiency in the n-th cycle (where n is an integer of equal to or greater than 2) is the ratio of the discharge capacity measured in the n-th cycle to the charge capacity measured in the n-th cycle. In other words, the round-trip efficiency in the n-th cycle can be defined using the following expression:

$$( Round \text{-} trip efficiency in n \text{-} th cycle ) = ( Discharge capacity in n \text{-} th cycle ) / ( Charge capacity in n \text{-} th cycle )$$

FIG. 3 is a partial enlarged view of the graph illustrated in FIG. 2. In FIG. 3, the horizontal and vertical axes show the number of cycles and round-trip efficiency, respectively, similarly to FIG. 2.

The results illustrated in FIGS. 2 and 3 confirm that the test cell prepared in Example (i.e., the test cell that included only VC as a solvent) had markedly high cycle characteristics compared with the test cells prepared in Comparative examples 1 to 4. That is, the test cell prepared in Example had higher cycle characteristics than the test cells prepared in Comparative examples 1 and 2 (i.e., the test cells that included a mixed solvent including VC and a solvent other than VC). The test cell prepared in Example had higher cycle characteristics than the test cells prepared in Comparative examples 3 and 4 (i.e., the test cells that included a solvent other than VC).

The above results confirm that the use of a solvent composed only of VC may markedly enhance the cycle characteristics of the nonaqueous electrolyte secondary battery.

By the technique according to the present disclosure, a nonaqueous electrolyte secondary battery having markedly improved cycle characteristics may be provided.

What is claimed is:

1. A nonaqueous electrolyte secondary battery comprising:
a positive electrode capable of occluding and releasing lithium;
a negative electrode including a negative electrode current collector; and
an electrolyte solution including a solvent, wherein
lithium metal precipitates on the negative electrode during charging,
the lithium metal dissolves in the electrolyte solution during discharging, and
the solvent is composed only of vinylene carbonate.

2. The nonaqueous electrolyte secondary battery according to claim 1,
wherein the negative electrode current collector is composed of a metal that does not alloy with lithium.

3. The nonaqueous electrolyte secondary battery according to claim 2,
wherein the negative electrode current collector includes copper.
